(19) United States
(12) Patent Application Publication
(10) Pub. No.: US 2011/0053427 A1
(43) Pub. Date: Mar. 3, 2011

(54) ELECTRICAL CONNECTOR HAVING TWO INSULATIVE RETAINERS FOR POSITIONING TERMINALS

(75) Inventors: CHANG-HSIEN TUNG, Tu-Cheng (TW); KUO-CHUN HSU, Tu-Cheng (TW)

(73) Assignee: HON HAI PRECISION INDUSTRY CO., LTD., Tu-Cheng (TW)

(21) Appl. No.: 12/875,148

(22) Filed: Sep. 3, 2010

(30) Foreign Application Priority Data
Sep. 3, 2009 (TW) 98216237

(51) Int. Cl. H01R 24/00

(52) U.S. Cl. 439/660

(57) ABSTRACT

An electrical connector includes an insulative housing (1) with a base portion (11) and an engaging portion (12) extending from the base portion (11), a plurality of contacts (2) which defines a retaining portion (201), a contacting portion (202) extending from the retaining portion and a soldering portion (203) extending outwards from the retaining portion (201) and a first insulative retainer (4) and a second insulative retainer (5) opposite to each other and assembled in the insulative housing. The first insulative retainer (4) has a plurality of through-holes (41) receiving the soldering portion therein (203), while the second insulative retainer includes a plurality of recesses (52) corresponding with the contacts (2) which include a plurality of intermediate connecting portions (204) received therein and interconnecting with the retaining portion (201) and soldering portions (203) unitarily.

### BACKGROUND OF THE INVENTION

1. Field of the Invention

The present invention relates to an electrical connector, and more particularly to a right-angled type electrical connector having two insulative retainers coordinating with each other so as to position a plurality of terminals therebetween.

2. Description of the Related Art

Japan Pat. No. 3366250 issued on Nov. 1, 2002, discloses an electrical connector. The connector includes an insulative housing, a plurality of contacts received in the insulative housing and a retaining spacer attached on the insulative housing. The insulative housing has a base portion and an engaging portion extending forward from the base portion. Each of the contacts defines a retaining portion held in the housing, a contacting portion extending from one end of the retaining portion into the engaging portion and a soldering tail integrally connected to another end of the retaining portion at a right angle. The retaining spacer includes a plurality of through-holes for receiving and positioning the soldering tails which extend through thereof. However, it is without the function of dust-proof because of absent of protecting measures for the contacts. Additionally, when the terminals are assembled with the retaining spacer, the soldering tails of the terminals will be deviated from their original position if they are pushed by the retaining spacer upwardly.

U.S. Pat. No. 6,860,744 issued to Maruyama et al. on Mar. 1, 2005, shows a low-profile connector having an insulative housing and a plurality of terminals parallel-arranged in the insulative housing. The insulative housing defines a base portion and an engaging portion extending from the base portion. Each of the terminals includes a soldering tail and a contacting portion connecting to the soldering tail and extending into the engaging portion for electrical connection with a mating connector. The terminal defines an intermediate crank-like portion and a right-angled connecting portion integrally connecting with the intermediate crank-like portion and the soldering tail. The right-angled connecting portion is pressed against by a protecting ceiling which unitarily extends from the base portion of the insulative housing for dustproof and preventing the terminals from overly-deflected. However, in such a manner that the structure of insulative housing is complicated and the terminal is unable to be easily assembled into the insulative housing.

Therefore, an improved electrical connector is desired to overcome the disadvantages of the related arts.

### SUMMARY OF THE INVENTION

An object of the present invention is to provide an electrical connector having two insulative retainers in which the contacts can be readily and easily assembled onto a connector housing without encountering any disadvantages as well as laborious assembling process.

In order to achieve the above-mentioned object, an electrical connector in accordance with a preferred embodiment of the present invention includes an insulative housing with a base portion and an engaging portion extending from the base portion, a plurality of contacts which defines a retaining portion, a contacting portion extending from the retaining portion and a soldering portion extending outwards from the retaining portion and a first insulative retainer and a second insulative retainer opposite to each other and assembled in the insulative housing. The first insulative retainer has a plurality of through-holes receiving the soldering portion therein, while the second insulative retainer includes a plurality of recesses corresponding with the contacts which include a plurality of intermediate connecting portions received therein and interconnecting with the retaining portion and soldering portions unitarily.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the preferred embodiment of the present invention;

FIG. 2 is an exploded perspective view of FIG. 1 without showing a metal shell;

FIG. 3 is a cross-section view of the electrical connector taken along line 3-3 of FIG. 1;

FIG. 4 is a cross-section view of the electrical connector taken along line 4-4 of FIG. 1;

FIG. 5 is a perspective view of an insulative retainer engaging with terminals of FIG. 2; and

FIG. 6 is a partly enlarged perspective view of FIG. 5.

### DETAILED DESCRIPTION OF THE INVENTION

Reference will now be made to the drawing figures to describe the preferred embodiment of the present invention in detail.

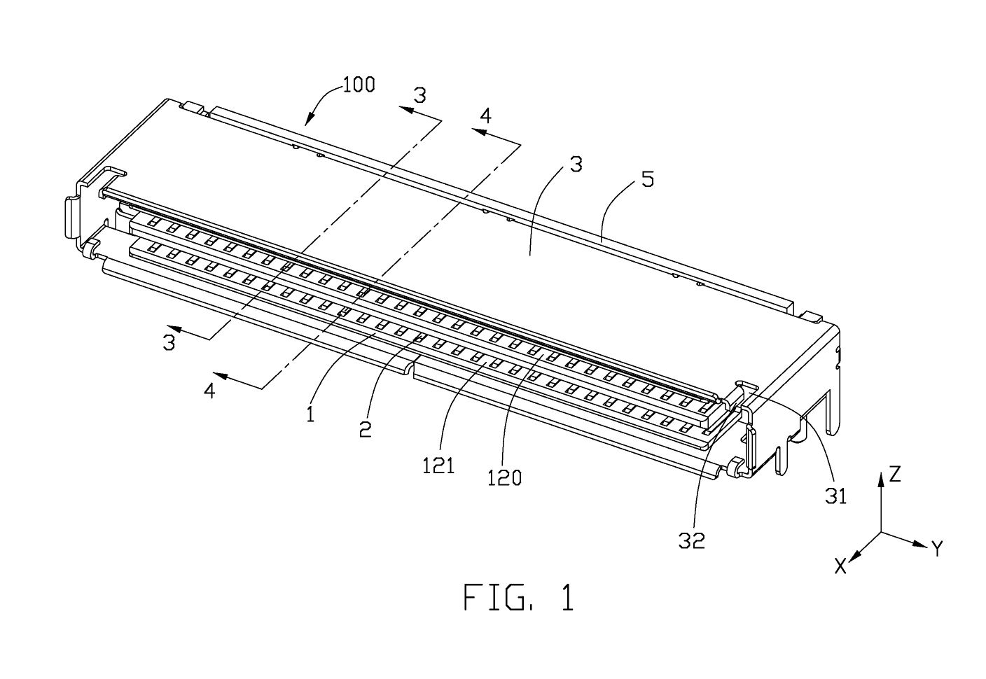

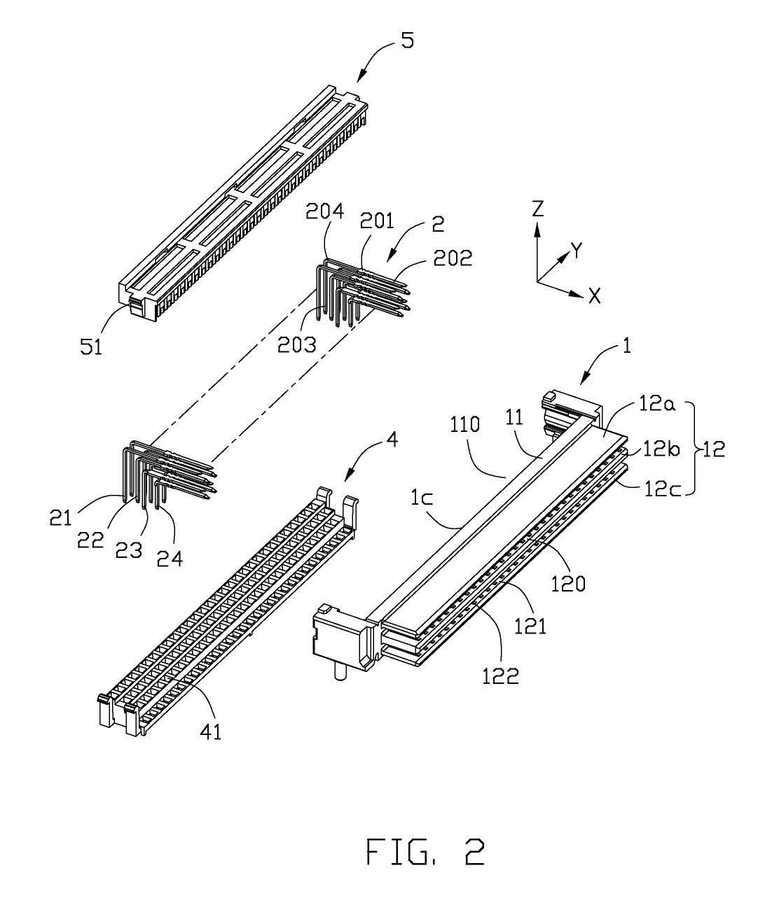

Referring to FIGS. 1 and 2, an electrical connector 100 includes an insulative housing 1 with a base portion 11 and an engaging portion 12 extending from the base portion 11 in a mating direction (i.e. an X direction), a plurality of contacts 2 inserted into the base portion 11 from a rear side 1c of the insulative housing 1 in the X direction and arranged along a longitudinal direction (i.e. a Y direction) perpendicular to the X direction, a metal shell 3 covering the insulative housing 1, a first insulative retainer 4 locking with the base portion 11 and a second insulative retainer 5 attached to the base portion 11.

The engaging portion 12 of the insulative housing 1 defines three tongue plates (i.e. a first tongue plate 12a, a second tongue plate 12b and a third tongue plate 12c), thereby forming a first mating room 120 and a second mating room 121 for receiving a mating connector (not shown). The base portion has a recess 110 for receiving the second insulative retainer 5 therein. The second insulative retainer 5 is inserted into the recess 110 along the Y direction and defines a pair of blocking portions 51 engaged with an inner surface of the recess 110 for positioning thereof in the insulative housing 1 steadily. The insulative housing 1 includes a plurality of grooves 122 extending from the base portion into engaging portion 12 for receiving the contacts 2 respectively therein. The contacts 2 are inserted into the grooves 122, each of which includes a retaining portion 201 retained in the insulative housing 1, a contacting portion 202 extending from one end of the retaining portion 201 into the engaging portion 12, a soldering tail 203 extending from another end of the retaining portion 201 and a reverse L-shaped intermediate connecting portion 204 unitarily connecting with the soldering tail 203 and the retaining portion 201.

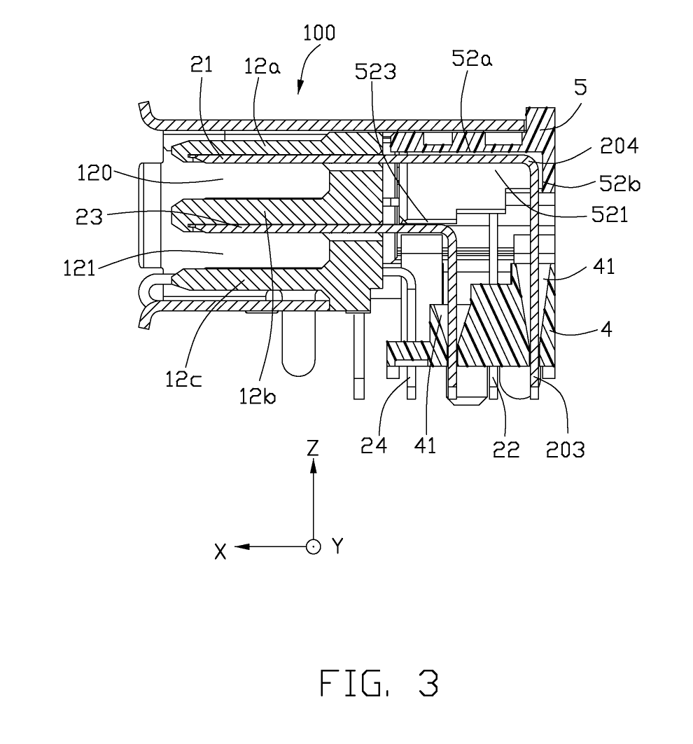

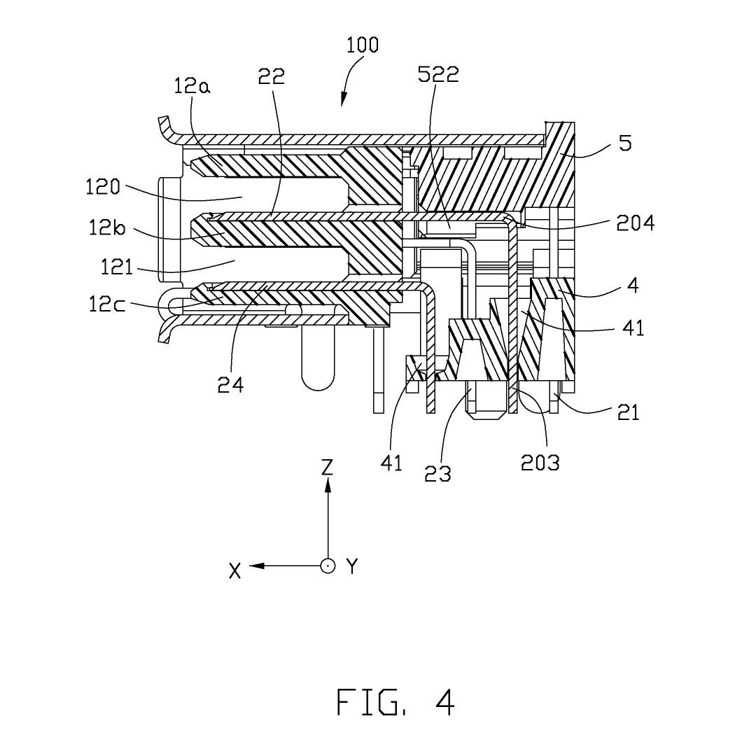

Referring to FIGS. 3 and 4, the contacts 2 are grouped into a set of first contacts 21, a set of second contacts 22, a set of third contacts 23, and a set of fourth contacts 24. The first contacts 21 and the second contacts 22 are opposite to each other in the first mating room 120 while the third contacts 23 and the fourth contacts 24 are opposite to each other in the second mating room 121. The first contacts 21 are disposed on the first tongue plate 12a and opposite to the second contacts 22 which are disposed on one side of the second tongue plate 12b. Furthermore, the third contacts 23 are disposed on another side of the second tongue plate 12a and opposite to the fourth contacts 24 which are disposed on the fourth tongue plate 12c. Each pair of the first contact 21 and the second contact 22 in the first mating room 120 are staggered with each other for decreasing the pitch of the two contacts 2 while lowering a cross-talking between of the contacts 2. The relationship of the third contacts 23 and the fourth contacts 24 are similar to that of the first contacts 21 and the second contacts 22.

The first insulative retainer 4 is assembled into the base portion 11 along a vertical direction (i.e. a Z direction) and blocked with the base portion 11, thereby forming an opposite relationship with the second insulative retainer 5 in the Z direction. The soldering tails 203 of the contacts 2 are also divided into four arrays in the Y direction and extending through the first insulative retainer 4 which defines a plurality of through-holes 41 for receiving and positioning the soldering tails 203.

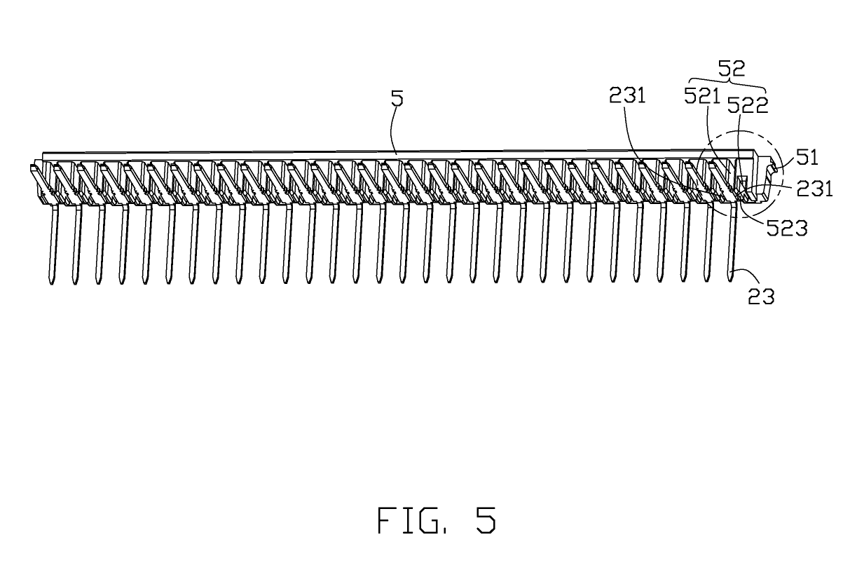

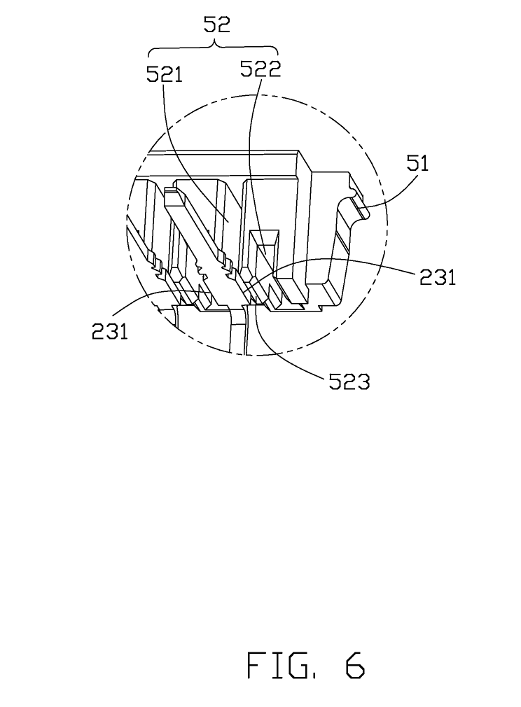

Referring to FIGS. 3 to 6, the second insulative retainer 5 includes a plurality of recesses 52 matching even or engaging with the intermediate connecting portions 204 of the contacts 2 for receiving and positioning the intermediate connecting portions 204 therein. The recesses 52 are opened to the first insulative retainer 4, thereby forming a balanced force system acting on the intermediate connecting portions 204 for preventing the contacts 2 from movement and deviating from original position thereof. The recesses 52 includes a plurality of first recesses 521, a plurality of second recesses 522 which are shallower than the first recesses 521 and staggered with the first recesses 521 and a plurality of spacing wall 523 disposed between each first recess 521 and second recess 522. Each of the first recesses 521 defines a first positioning surface 52a and a second positioning surface 52b perpendicular to each other at inner side thereof for respectively preventing the intermediate connecting portions 204 from moving in the Z direction and a reverse direction of the X direction.

Referring to FIGS. 3 to 5, the first contacts 21 are received and positioned in the first recesses 521 respectively. The second contacts 22 are received and positioned in the second recesses 522 respectively. Each of the third contacts 23 straddles upon the first recess 52 and has a pair of protruding ears 231 respectively pressing against on the two adjacent spacing walls 523. So that the four sets contacts 2 are disposed in the insulative housing 1 in a smaller a spacing pitch of each two contacts 2. But the fourth contacts 24 are not engaged with the second insulative retainer 5 because its soldering tails are shorter than the other three sets contacts (i.e. the first contacts 21, the second contacts 22 and the third contacts 23) and closer than the insulative housing in the Y direction.

Referring to FIGS. 1 and 2, the metal shell 3 is formed by a unitary metallic plate and includes a pair of openings 31 for anti-mismating of the mating connector and a pair of tongue tabs 32 each integrally connected with inner edge of the opening 31 for guiding the mating connector inserted into.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. An electrical connector, comprising:
an insulative housing comprising a base portion and an engaging portion extending from the base portion;
a plurality of contacts, each of which comprising a retaining portion retained in the insulative housing, a contacting portion extending from the retaining portion for disposed in the engaging portion and a soldering portion extending outwards from the retaining portion;
a first insulative retainer and a second insulative retainer opposite to each other and assembled in the insulative housing; and
wherein the first insulative retainer comprises a plurality of through-holes receiving the soldering portion therein, while the second insulative retainer comprises a plurality of recesses corresponding with the contacts which include a plurality of intermediate connecting portions received therein and interconnecting with the retaining portion and soldering portions unitarily.

2. The electrical connector as described in claim 1, wherein intermediate connecting portions are L-shaped configuration.

3. The electrical connector as described in claim 2, wherein the recesses are opened to the first insulative retainer, thereby forming a balanced force system acting on the intermediate connecting portions.

4. The electrical connector as described in claim 3, wherein the recesses comprises a plurality of first recesses, a plurality of second recesses which are shallower than the first recesses and staggered with the first recesses.

5. The electrical connector as described in claim 4, wherein the contacts comprises a plurality of first contacts and a plurality of second contacts respectively corresponding with in the first recesses and the second recesses.

6. The electrical connector as described in claim 2, wherein the second insulative retainer comprises a plurality of spacing walls disposed between each two adjacent recesses.

7. The electrical connector as described in claim 6, wherein the contacts comprises a plurality of third contacts, each of which is pressed against on two adjacent spacing walls.

8. The electrical connector as described in claim 7, wherein each of the third contacts straddles upon the recess and comprises a pair of protruding ears pressing against on the two adjacent spacing walls.

9. The electrical connector as described in claim 3, wherein the base portion comprises a receiving recess for receiving the second insulative retainer therein which forms a pair of blocking portions engaging with the receiving recess.

10. An electrical connector comprising:
an insulative housing defining a front mating port and a rear mounting port along a front-to-back direction;
a plurality of contacts disposed in the housing, each of said terminal defining a horizontal section including a front mating portion and a rear retention portion behind the front mating portion in said front-to-back direction, and a vertical mounting section extending downwardly from a rear portion of the horizontal section with a joint therebetween, said contacts being arranged with at least upper and lower rows each extending in a transverse direction perpendicular to said front-to-back direction while being spaced from each other in a vertical direction, which is perpendicular to said front-to-back direction and said transverse direction, for the corresponding horizontal sections, and also with at least front and rear rows each extending along said transverse direction while being spaced from each other in said front-to-back direction for the corresponding vertical mounting sections which extend from the corresponding horizontal sections in said lower and upper rows; and
an upper spacer secured relative to the housing and defining a plurality of spaced recesses to receive the rear portion of the horizontal sections of the corresponding contacts in the upper row for preventing upward movement of the vertical mounting sections of the corresponding contacts, and further defining a plurality of spaced walls located below and between the corresponding recesses, respectively, to support the rear portions of the horizontal sections of the corresponding contacts in the lower row for preventing upward movement of the vertical mounting sections of the corresponding contacts; wherein
the contacts are arranged with pairs to have said corresponding horizontal sections in the upper row essentially aligned with the corresponding horizontal sections in the lower row in said vertical direction.

11. The electrical connector as claimed in claim 10, wherein the rear portion of the horizontal section of each corresponding contact in the lower row defines a pair of laterally protruding ears for abutting against the corresponding wall in said vertical direction for preventing upward movement of the vertical mounting section of the corresponding contact.

12. The electrical connector as claimed in claim 11, wherein the rear portion of the horizontal section of each corresponding contact in the upper row lacks said pair of laterally protruding ears so as to allow said rear portion to be received in the corresponding recess between two corresponding spaced walls.

13. The electrical connector as claimed in claim 10, wherein the contacts are further arranged with a middle row between the front row and the rear row in the front-to-back direction for the corresponding vertical mounting sections of the contacts.

14. The electrical connector as claimed in claim 13, wherein the upper spacer further defines a plurality of spaced grooves respectively between the corresponding recesses to receive the rear portions of the horizontal sections of the contacts whose vertical mounting sections are located in the middle row, for preventing upward movement of said horizontal sections.

15. The electrical connector as claimed in claim 13, wherein the horizontal sections of the contacts having the vertical mounting sections in the middle row are arranged in a middle row between the upper row and the lower row in the vertical direction.

16. The electrical connector as claimed in claim 10, wherein the contacts are further arranged with another row spaced from the upper row and the lower row in the vertical direction for the corresponding horizontal sections of the contacts.

17. The electrical connector as claimed in claim 16, wherein said another row is located between the upper row and the lower row.

18. An electrical connector comprising:
an insulative housing defining opposite front mating port and rear mounting port in a front-to-back direction;
a plurality of contacts disposed in housing;
a plurality of contacts disposed in the housing, each of said terminal defining a horizontal section including a front mating portion and a rear retention portion behind the front mating portion in said front-to-back direction, and a vertical mounting section extending downwardly from a rear portion of the horizontal section with a joint therebetween, the contacts being categorized with first, second and third types and the corresponding horizontal sections of said contacts being arranged with upper, middle and lower rows in a vertical direction perpendicular to said front-to-back direction, and the corresponding vertical mounting sections of said contacts being arranged with front, median and rear rows in said front-to-back direction corresponding to the horizontal sections in said lower, middle and upper rows under condition that the contacts of the first type have the corresponding horizontal sections in the upper row and the vertical mounting sections in the rear row, the contacts of the second type have the corresponding horizontal sections in the middle row and the vertical mounting sections in the median row, and the contacts of the third type have the corresponding horizontal sections in the lower row and the corresponding vertical mounting sections in the front row;
an upper spacer secured relative to the housing and defining larger and small recesses alternately arranged in a transverse direction perpendicular to both said front-to-back direction and said vertical direction, to respectively receive rear portions of the horizontal sections of the contacts of the first type and those of the second type for preventing upward movement of the corresponding horizontal sections, wherein
said upper spacer further defines a plurality of spaced downwardly walls between the corresponding large and small recesses respectively under condition that the horizontal sections of the contacts of the third type upwardly abuts against the corresponding downward walls, respectively, for preventing upward movement of the horizontal sections of the contacts of the third type.

19. The electrical connector as claimed in claim 18, wherein the rear portions of the horizontal sections of the contacts of the third type are wider than those of the contacts of the first type and the second type for abutting against the corresponding downward walls instead of receipt within the corresponding first and second recesses.

20. The electrical connector as claimed in claim 19, wherein the horizontal sections of the contacts of the third type are essentially aligned with either those of the contacts of the first type or those of the contacts of the second type.
